(19) United States
(12) Patent Application Publication
(10) Pub. No.: US 2005/0097615 A1
(43) Pub. Date: May 5, 2005

(54) System for selecting and optimizing display of video files

(75) Inventors: Ahmad Moradi, Ft. Lauderdale, FL (US); Arash Jalali, Ft. Lauderdale, FL (US)

Correspondence Address: FLEIT KAIN GIBBONS GUTMAN & BONGINI, COURVOISIER CENTRE II, SUITE 404, 601 BRICKELL KEY DRIVE, MIAMI, FL, 33131, US

(73) Assignee: G-4, Inc., Ft. Lauderdale, FL (US)

(21) Appl. No.: 11/011,537

(22) Filed: Dec. 14, 2004

Related U.S. Application Data
(63) Continuation-in-part of application No. 10/634,733, filed on Aug. 5, 2003.

(51) Int. Cl. H04N 7/173; G06F 15/16

(52) U.S. Cl. 725/90; 725/88; 725/89

(57) ABSTRACT

A method for playing back video files optimizes display viewing while minimizing file size. One of a plurality of video files representing the same video production is automatically selected for viewing based on multiple criteria, such as network bandwidth, the type of video players available to display the video file, the format of the video file and the platform used to display the file. The width and height of the image displayed from the selected video file is adjusted to match the resolution of a display screen, or a user specified image size.

### RELATED APPLICATIONS This application is a continuation-in-part of U.S. patent application Ser. No. 10/634,733, filed Aug. 5, 2003.

### BACKGROUND OF THE INVENTION

1. Field of the Invention

This invention generally relates to techniques for displaying video files, and deals more particularly with a method for selecting and optimizing the display of video files in differing formats.

2. Prior Art

It has been proposed to use email as a means of sending advertising and marketing information in the form of video clips attached and or streamed to or forming a part of email messages to targeted destinations. The challenge with e-mailing video on the web has always been watching the video either universally through a click or automatically based on individual desktop settings populated by various media formats, bandwidth and compatibility. Until recently, all e-mailed video commercials developed required a special player, plug-in and or executables to view it, and none had the ability to play automatically on popular email programs (e.g. Outlook, Outlook Express, Incredimail). In U.S. patent application Ser. No. 10/634,733 filed Aug. 5, 2003, assigned to the assignee of the present application, the inventors propose a method and apparatus for producing video e-mail that overcome these limitations and which can be used effectively as a marketing tool.

The invention disclosed in the aforementioned patent application provides a method and apparatus for generating and marketing video e-mail and to an intelligent server that can function as an ad server. This is accomplished by providing video and sound in one small envelope to create a new vehicle as the basis for e-mail marketing to or for advertisers, businesses and service companies. The generated video e-mail meets the challenge in the art by generating an e-mailing video with an appropriate file size, bandwidth and compatibility. Further, the generated e-mailed video commercial requires no special player to view it, and has a very small file size, of under 800K for thirty-seconds of video when sent as an attachment. The file size of video e-mailing when sent as a streaming work with ad-server is no more than 15K (Kilo Byte). By the advent of this invention, instead of a text message, the business world can send a video message that offers the dynamics of color, movement and sound.

The delivery and display of video email is complicated by the fact that intended recipients use communication appliances, e.g. PCs, PDAs, etc., that employ a variety of media player formats and are connected to the internet at a variety of speeds. A challenge therefore exists in choosing the type of media file which is to be displayed in order to provide the user with the best viewing experience. This problem is exacerbated by the fact that differing types of media files of the same video production have differing pixel resolutions. As a result, the width and height of the video that would ordinarily be displayed for a chosen file type may not be optimized for the particular configuration of the viewer's computer, and the bandwidth of the viewer's connection. Accordingly, there is a need in the art for a method of selecting and displaying video files in a manner that overcomes the deficiencies mentioned above.

### SUMMARY OF THE INVENTION

In accordance with the present invention, a method is provided for selecting video file that best suits the user's network and player configuration. The ultimate recipient of the video email is able to watch the right video format without any decision on their part. An algorithm finds the optimum choice among the qualified players, media settings, desktop settings, and bandwidth connection. The inventive method includes the steps of identifying the right media files for user viewing, and scoring each possible media file. The file that has the highest scores wins and is selected. The scoring and decision criteria have 2 components: format conformity score, and connection speed score.

More specifically, the invention contemplates computing the user's best viewing protocol comprising one or more of the following steps. Defining a scoring system for viewing video format. Feeding the value of the scored to algorithm engine(s) for measuring the highest probability value also known as “Certainty Factors”. Creating a scoring methodology for speed and bandwidth connectivity and establishing the Certainty Factor. Establishing scoring values for associating file format extension to the media player located at viewing computer settings hence defining Certainty Factor values. Measuring wrong media format association with a media player in form of conformity will produce the least Certainty Factor value system. Measuring right media format association with right media player produces the highest Certainty Factor value for conformity. Placing Certainty Factor values into algorithm engine(s) and creating decision criteria. (e.g. sending the highest valued video for streaming or emailing). Defining connection speed methodology where value is referred to as raw speed. Creating a file size assessment computation where such value is referred to as bias factor. Taking into account the raw speed and bias factor and defining a score setting using algorithm engine(s) for its most suitable viewing on a computer screen. Converting those values into machine code language for its placement into hosting web sites streaming from an intelligent server or placing such machine code parameters into video emailing for broadcasting to email recipient.

According to the present invention, a video file playback method is provided, comprising at least the steps of: selecting one from at least two video files representing the same video production but having differing video play-back qualities; generating an video image by playing back the selected video file; and, adjusting at least one of the height and width of the generated video image. The inventive method adjusts the width and height of the playback of the selected file to optimize user viewing. Height and width adjustments are made based on the configuration of the user's computer as well as the preferred size for each bandwidth.

Other feature and advantages of the present invention will become apparent from the following detailed description of preferred embodiments of the invention when taken in conjunction with the appended drawings.

### BRIEF DESCRIPTION OF THE DRAWINGS

FIG. 1 is a flow chart showing the broad steps for displaying sending and displaying a video file forming part of a video email;

FIG. 2 is a flow chart showing the steps for automatic selection of a video file; and,

FIG. 3 is a flow chart showing the steps for scoring player conformity.

### DETAILED DESCRIPTION OF PREFERRED EMBODIMENTS OF THE INVENTION

The present invention will now be described in detail with reference to the appended drawings.

An Intelligent Video Streaming Server and related logic (hereinafter “IVSS”) is disclosed in the above referenced U.S. patent application Ser. No. 10/634,733, the entire contents of which are hereby incorporated by reference herein. In accordance with the invention disclosed in this prior application, video email is generated by combining video and sound in one small envelope that can be emailed for a variety of applications, such as marketing, advertising and other service applications. The video e-mail is generated in an appropriate file size, bandwidth and compatibility. The generated e-mailed video requires no special player to view it, and has a very small file size e.g. under 800K for thirty-seconds of video when sent as an attachment. The file size of the video e-mail when sent as a streaming work with ad-server is no more than 15K (Kilo Bytes). By the advent of this prior invention, instead of a text message, the business world can send a video message that offers the dynamics of color, movement and sound.

The present invention comprises a method for selecting and optimizing the display of video files, such as those accompanying the video emails mentioned above. Because the method is well adapted for use with the IVSS and related techniques, for sake of illustration, the inventive method will be described herein in its application for displaying video email files managed by the IVSS. However, it should be understood that the present method can also be used in many other applications and with a variety of systems and platforms wherein it is desired to optimize the display of video files.

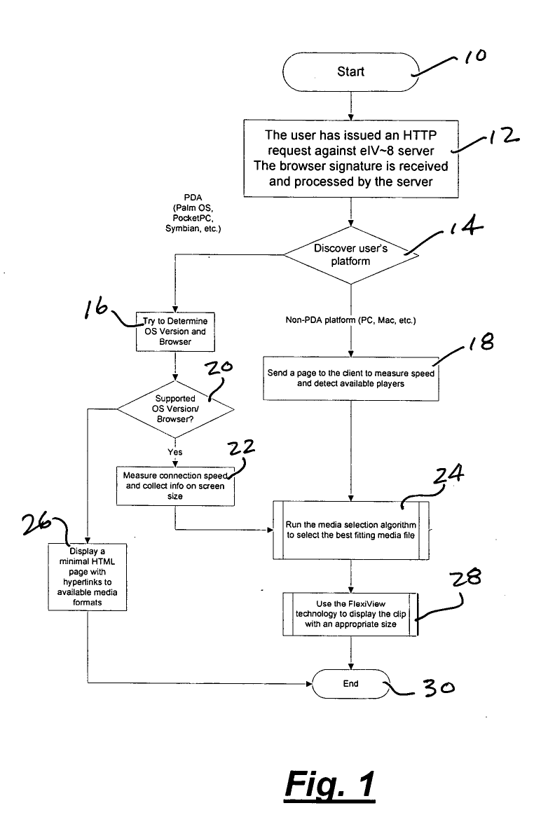

FIG. 1 is a flow chart showing the broad steps comprising the method by which a media file is selected by the IVSS for playing on a user's computer. Beginning at the start 10, the user issues an HTTP request against the IVSS server, following which the browser signature is received and processed by the IVSS. Then, at step 14, a decision is made regarding the type of platform being used by the user. If the platform is a non-PDA platform, i.e. PC, Mac, etc, then the process proceeds to step 18 where the IVSS sends a page to the user in order to measure the speed and detect the players that are available on the users computer. Having detected the connection speed and the players available at the user's site, the process proceeds to step 24 in which the media selection algorithm is run in order to select the best fitting media file. Returning to step 14, in the event that the detected platform is a PDA, then the process proceeds to step 16 where an attempt is made to determine the type of OS (operating system) version and browser. At step 20, if the OS version/browser is one that is supported, then the process continues to step 22 where the connection speed is measured and information is collected regarding the users screen size. Following step 22, the process proceeds to step 24 where the media selection algorithm selects the best fitting media file. If, however, the OS version/browser is not one that is supported, then, at step 26, a minimal HTML page is displayed with hyperlinks to available media formats. If the operating system version/browser is supported, then following the selection of the best fitting media file at step 24, a procedure is carried out at step 28 which displays the video clip at a size that best fits the users screen. The process ends at step 30.

The procedure by which a video e-mail is streamed or a web browser watches media file, is selected by the IVSS will now be described in more detail. Media files are first categorized by their preferred media player as determined by the client or customer while uploading the file, their associated network connection also as determined by the customer, and their format as determined by their file extension, e.g. MPG, WMA, etc., as well as their intended target platform (PC, PDA, etc.). For example, an MPEG file uploaded for being played whenever the recipient or user (visitor) has a LAN connection and associated with the Windows Media Player on a PocketPC could be called mod ppcmp myfile.mpg.

At the time the visitor wishes to watch/listen to a certain media (video/audio clip) that is hosted by the IVSS, an intelligent auto-player selects the file that best suits the visitor's platform as well as her network and player configuration. There may be times that only one file qualifies for being played, however, usually the browser (of the recipient) may have a number of qualified media players installed in his/her computer settings. Accordingly, an algorithm is provided for finding the optimum choice among the qualified media players, media formats, desktop settings, and bandwidth connection.

In the description that follows, a “modem” connection means any network connection with a speed of less than or equal to 4 Kilobytes per second, and a LAN connection means any network connection with a speed equal to or more than 10 megabits per second on a non-PDA device. Therefore, the terms “modem” and “LAN”, as used herein, do not necessarily reflect the kind of networking technology and apparatus used by a recipient or user. Furthermore, a Pocket PC PDA is defined as any hand-held device running some version of Microsoft Windows CE/Pocket PC operating system and a Palm PDA is any hand-held device running some version of the Palm OS operating system.

Assume first that the following files are uploaded for a certain clip called MYVI DEO:
mod_mp_myvideo.wmv
lan_mp_{—}9_myvideo.wmv
lan_rp_myvideo.rm
mod_qt_{—}6-1_myvideo.mov
mod_qt_myvideo.mpg
mod_rp_myvideo.mpe
256_wm_{—}10_myvideo.wmv
384_fl_myvideo.swf
768_rp_myvideo.rm
1500_qt_myvideo.mov
768_ppcmp_myvideo.wmv

When a user tries to play this clip using an auto-player, for example, the system will try to determine the platform from which the request is made based on the signature of the user's browser or media player. The platform will then be identified as one of the following:
A Pocket PC PDA running some version of the Pocket Internet Explorer Browser (this platform will be denoted ppc)
A Palm PDA running some version of the Palm Web Browser (platform denoted by palm)
A non-PDA machine

If the detected platform is determined to be a PDA, then a suitable page containing platform-compatible scripts is sent to the PDA to measure its bandwidth speed, and if it is a non-PDA platform, another page is sent to measure the connection speed as well as to determine the available movie players installed on the user's machine.

Regardless of the detected platform, the subsequent speed measurement will help the server system narrow down the file choices it has for playing back to the user to those which are associated with the closest speed to the measured speed. The server system will first normalize the measured speed to match it with the closest standard speed. Table 1 lists typically supported standard speeds. The calculated standard speed will determine the prefix of the narrowed down choices for playback. For instance, when a user with a measured speed of 34 Kbps uses the auto-player, the closest standard speed will be the 56 Kbps modem speed and therefore the choices will be narrowed down to those files that start with mod_. Reference to “the closest” standard speed means the closest speed that is available. For instance, in the example of the above eight clips files, if the measured speed is 290 Kbps, then closest (available) standard speed is 384 Kbps and not 256 Kbps.

TABLE 1

| Standard Bandwidth Name | Description |
|---|---|
| Modem | All connections with a |
| | bandwidth lower than or |
| | equal to 56 Kbps |
| 128-64 | ISDN Connection |
| 256 | DSL connection |
| 384 | DSL connection |
| 512 | DSL connection |
| 768 | DSL connection/WiFi |
| 1000 | T1 |
| 1500 | T1 or E1 Connection |
| LAN | All connections with |
| | bandwidths starting from |
| | 10 Mbps upwards |

On non-PDA platforms, the list of installed video players along with their version numbers on the user's machine will also be detected and sent back to the IVSS by a piece of client-side script. This will help server system further narrow down the list of choices for play-back even further. For instance, in the above example, the possible choices for a user with a close to modem connection speed are:
mod_mp_myvideo.wmv
mod_qt_{—}6-1_myvideo.mov
mod_qt_myvideo.mpg
mod_rp_myvideo.mpe

Of these four, two are associated with the QuickTime player, one with RealPlayer, and one with the Windows Media Player. Assuming the user has both QuickTime and Windows Media Player installed on their machine; three out of the four above will qualify for being played and the one associated with the RealPlayer will be dropped out. In accordance with the present invention, an algorithm is provided for selecting the most appropriate installed player.

For PDA's the same procedure applies except that the files will be selected based on platform as well as speed, and if applicable installed players.

The present selection algorithm finds the correct file to be played by scoring each possible candidate file. The file that earns the highest score will be the one that is played.

Scores are comprised of two components:
1. Format conformity score (a value in the range 0-10) which consists of two subcomponents itself:
   a) Player brand conformity score (0-7)
   b) Player version conformity score (0-3)
2. Connection speed score (a value in the range 0-10)

The Player brand conformity score reflects how much a file's format (extension) goes with its customer-specified associated player. For example, a WMV file (a Microsoft proprietary format) best fits the Windows Media Player for obvious reasons. Now suppose this file is associated with the RealPlayer. This reduces its format conformity score to 5.6. A WMV file associated with the Windows Media Player scores 7, whereas it will score 5 if it is assigned to the RealPlayer. The less compatible the format is with the associated player, the less its player brand conformity score will be. An RM file associated with the Windows Media Player scores 0 because the Windows Media Player cannot play RM files.

The player version conformity score determines how well-equipped the current installed version of a player is for playing a certain file. Some files have a player version component in their names. For instance the file mod_qt_{—}6-1_myvideo.mov is specified by the user to be well suited for QuickTime players version 6.1 and above. So if a user's computer is equipped with QuickTime player version 6.5, then this file's player version conformity score will be 3, but if QuickTime 5.0 had been installed, the score for version conformity would have been 0. In addition to explicit version designation for files, which is done by the customer who uploads the file, some file codecs (represented by the file extension) could inherently be associated with specific versions of a player. For instance, files with the FLV extension can only be played by certain versions of Macromedia player upwards. Therefore, even if the user does not associate a file with a specific version number, the server system will try to score the file based on its inbuilt extension-player version conformity criteria.

Player brand conformity scores may be hard coded into the IVSS in the form of a look-up table. Table 2 below shows the player brand component of the format conformity score table which could, for example, be hard coded into IVSS. It should be noted here that Table 2 is provided merely for illustration, and that various other or subsequently created formats may be included in such a table.

TABLE 2

| | Associated Player | | | |
|---|---|---|---|---|
| | Windows Media | | | |
| Extensions | Player | RealPlayer | QuickTime | Flash |
| ra, ram, rm | 0.0 | 7.0 | 0 | 0.0 |
| rmm, rmj rmd | | | | |
| Mpeg, mpg, | 7.0 | 6.3 | 3.5 | 0.0 |
| mpe, mpa | | | | |
| mp2 | | | | |
| Wmv, wma, asf | 7.0 | 5.6 | 0.0 | 0.0 |
| Swf | 2.1 | 1.4 | 3.5 | 10.0 |
| avi, wav, au, | 7.0 | 5.6 | 0.0 | 0.0 |
| midi, mid | | | | |
| rmi, , m1v, | 7.0 | 0.0 | 0.0 | 0.0 |
| snd, | | | | |
| aif | | | | |
| Mov | 2.8 | 0.0 | 7.0 | 0.0 |

The connection speed score reflects how much the user's connection speed is compatible with the file's size. This score is calculated based on the assumption that the larger a file is, the higher its quality will be. The formula according to which the raw speed score is calculated is as follows:

$$RawSpeedScore = {( \frac{FileSize}{KBPS} )}^{β}$$

The file size is expressed in Kilobytes, KBPS is the connection speed expressed in Kilobytes per seconds and β is real number between −1 and 1 the bias factor.

A bias factor of 1 means that the score strictly favors larger (high quality) files. A bias factor of −1 means that the score strictly favors smaller (low quality, faster downloading) files. A bias factor of 0 means that the connection speed score will not be taken into account (the system does not discriminate among files based on their size). The bias factor is determined individually for each clip folder by the customer. This is indicated in the server system user interface as a sliding track bar labeled “Auto-play Performance”. When the track is slid towards the side indicated as “Best Quality”, the bias factor is moved closer to 1 and when it is slid towards “Better Speed” the bias factor is moved closer to −1. When the track is in the middle, the bias factor is zero.

The raw speed scores are then normalized into values in the range 0-10 by dividing them all by the highest speed score among the list of candidates. Therefore the speed score is a relative score and a file may be scored differently when appearing in different candidate lists.

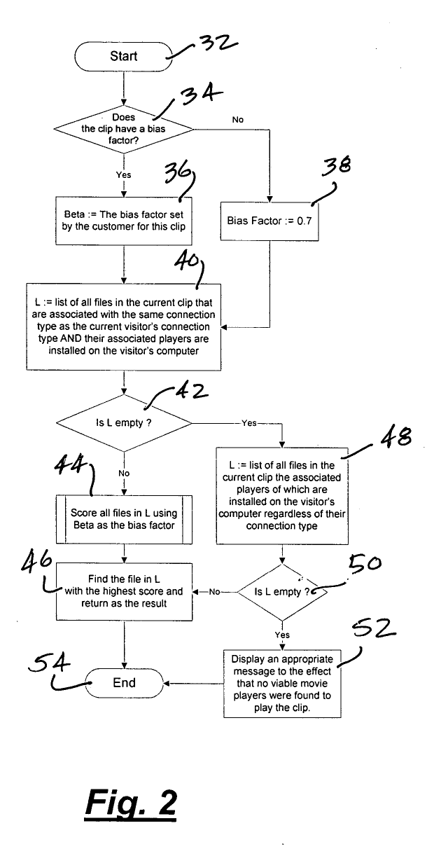

The media selection technique described above comprises a series of method steps which will now be further described in outline form with reference to the flow chart shown in FIG. 2. The selection process starts at step 32, following which a determination made of whether the video clip has a bias factor at 34. If the clip does not have a bias factor, then the bias factor is set equal to a predetermined value, herein chosen to be 0.7, as is shown at step 38. On the other hand, if the video clip does have a bias factor, it is set by the customer at step 36. The bias factor having been set, a list L is made at step 40 comprising all files in the current video clip that are associated with the same connection type as the current user's connection type and their associated players are installed on the user's computer. With the video clips and the associated players having been installed on the user's computer at step 40, a determination is made at step 42 as to whether the list L is empty. If the list is not empty, then all files and the list L are scored using beta as the bias factor, as shown at step 44. Then, at step 46, the file in the list L is selected having the highest score and this file is returned as a result at step 46. On the other hand, if the list L is empty then, L is set equal to the list of all files of the current video clip, the associated players of which are installed on the users computer regardless of their connection type, as shown in step 48. Then, a further determination is made of whether the list L is empty, at step 50. If the list L is not empty, the process progresses to step 46, however if the list is empty, the process proceeds to step 52 which consists of displaying an appropriate message to the effect that no viable movie players were found to play the video clip. Following the completion of either steps 46 or 52, the process ends at 54.

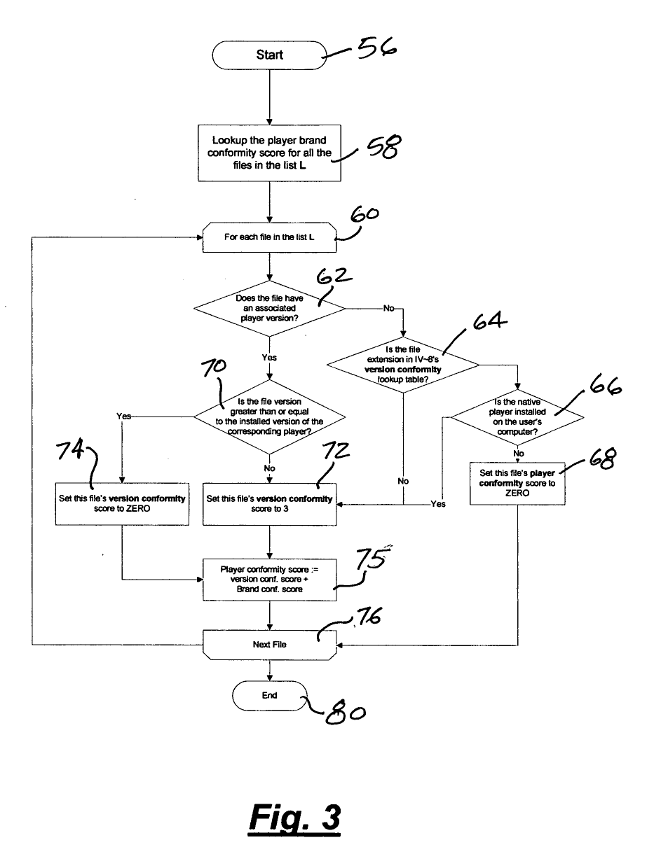

The player conformity scoring method described above will now be described in outline form with reference to the flow chart shown in FIG. 3. The scoring procedure starts at 56, following which a lookup is made of the player brand conformity score for all files listed in the list L as shown in step 58. Then, a series of steps are performed for each file in the list L as shown in step 60. First, a determination is made at step 62 as to which the file has an associated player version. If the file does have an associated player version, the process proceeds to step 70, otherwise the process proceeds to step 64 where a determination is made of whether the file extension is present in the IVSS version conformity lookup table. If the file extension is found in this lookup table, the process proceeds to step 66 where a determination is made as to whether the native player is installed on the user's computer. If the player is not installed in the user's computer, the process proceeds to step 68 where the files player conformity score is set to zero, following which the process proceeds to step 76. On the other hand, if the native player is found to be installed on the user's computer, the process proceeds to step 72.

At step 70, a determination is made as to whether the final version is greater than or equal to the installed version of the corresponding player. If the answer to the question posed at step 70 is “yes”, the process proceeds to step 74 wherein the file version conformity score is set to zero. If the answer to the question posed at step 70 is “no”, then the file version conformity score is set to 3, as noted at step 72. Following the setting of the conformity scores in steps 72 and 74, the player conformity score is determined based on the sum of the version conformity score plus the brand conformity score, as shown at step 75. With this scoring complete, the process is repeated for each file at step 76, until all the files have been processed, following which the procedure ends at step 80.

In addition to selecting the most appropriate candidate media file to be played, it is also desirable to optimize the display of the media file by adjusting the size of the file. The IVSS maintains typically different versions of the same video production with different play-back qualities. According to the present invention, the candidate that best fits the configuration of the user's computer and network connectivity is selected. However, due to the varying pixel resolution of these versions, it is sometimes desirable to play back each file with a specific and carefully selected width and height to give the user the best viewing experience possible. In accordance with the present invention, this width/height adjustment is performed based on the configuration of the user's computer as well as the preferred size associated with each bandwidth. At the time a visitor wants to watch a certain video clip the auto-player should be able to resize itself to playback the best fitting media clip in its most appropriate form.

As used in this description, the customer is an individual or company that has acquired a user name and password on the IVSS to create clip folders and upload audio/video files. Standard Bandwidth may comprise any of the numerous bandwidths supported by server system. All bandwidths measured by the system will ultimately be rounded to one of these standard bandwidths. Table 2 previously mentioned in connection with the media file selection process shows a list of standard bandwidths that would typically be supported.

In connection with the present invention, every standard bandwidth can be associated with a video size. For instance, if the “modem” bandwidth is associated with 240×180 then it means that a clip selected by the system to be played back to a user with a detected modem connection, will be displayed in a player frame size of 240×180 pixels. This association can be introduced to the system at two levels:
1. Global level: determined and adjustable by the IVSS administrator
2. Folder level: defined individually for each video folder by the customer that creates that folder.

The customer has also the choice of fixing the size of the clips played back irrespective of the detected bandwidth, in which case the method according to the present invention is disabled. The fixed player size configuration can both be statically specified at the folder level, or dynamically as a parameter passed to the player for a specific and particular play-back session.

Table 3 shows a sample size-bandwidth designation.

TABLE 3

| | Designated Player Size |
|---|---|
| Standard Bandwidth Name | (width × height) |
| Modem | 240 × 180 |
| 256 | 320 × 240 |
| 384 | 320 × 240 |
| 512 | 320 × 240 |
| 768 | 320 × 240 |
| 1500 | 800 × 640 |
| LAN | 800 × 640 |

Under certain circumstances, the IVSS automatically bypasses the user- or admin-defined designations and adjusts the size of the player to an appropriate width and height. This applies but is not limited to the following situations:
1. On PDA devices that specifically announce their display size in their browser identification string (a.k.a. browser signature). IVSS will snap the clip to the available screen width and height in case the designated size is larger than the size of the PDA's LCD.
2. On a non-PDA client, if the user has set the screen resolution to a size less than the designated size in IVSS, then the player will be adjusted to fit the user screen size.

Embodiments of the invention can be implemented as a program product for use with a computer system such as, for example, a cluster computing environment as described herein. The program(s) of the program product defines functions of the embodiments (including the methods described herein) and can be contained on a variety of signal-bearing medium. Illustrative signal-bearing medium include, but are not limited to: (i) information permanently stored on non-writable storage medium (e.g., read-only memory devices within a computer such as CD-ROM disk readable by a CD-ROM drive); (ii) alterable information stored on writable storage medium (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the present invention, whether implemented as part of an operating system or a specific application, component, program, module, object or sequence of instructions may be referred to herein as a “program.” The computer program typically is comprised of a multitude of instructions that will be translated by the native computer into a machine-readable format and hence executable instructions. Also, programs are comprised of variables and data structures that either reside locally to the program or are found in memory or on storage devices. In addition, various programs described herein may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It is also clear that given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.) It should be appreciated that the invention is not limited to the specific organization and allocation or program functionality described herein.

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

Each computer system may include, inter alia, one or more computers and at least a signal-bearing medium allowing a computer to read data, instructions, messages or message packets, and other signal bearing information from the signal bearing medium. The signal-bearing medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the signal bearing medium may comprise signal bearing information in a transitory state medium such as a network link and/or a network interface, including a wired network or a wireless network, that allow a computer to read such signal bearing information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the spirit, scope and contemplation of the invention as defined in the appended claims.

1. A video file play-back method, comprising the steps of:
(A) selecting one from at least two video files representing the same video production but having differing video play-back qualities;
(B) generating a video image by playing back the video file selected in step (A); and,
(C) adjusting at least one of the height and width of the video image generated in step (B).

2. The method of claim 1, including the step of storing a plurality of video files each representing the video production but having differing video play-back qualities

3. The method of claim 1, wherein the selection made in step (A) is based on at least one of the following:
the type of video player available to a user for play-back of video files,
the bandwidth available in a network for transmission of video files to a user,
the format of each of the video files,
the type of platform available to the user for play-back of video files.

4. The method of claim 1, wherein the selection made in step (A) is based on a combination of:
the type of video player available to a user for play-back of video files,
the bandwidth available in a network for transmission of video files to a user,
the format of each of the video files,
the type of platform available to the user for play-back of video files.

5. The method of claim 1, including the steps of:
(D) measuring the speed of a network connection used to send video files to a site where the video file is played back,
(E) collecting information relating to characteristics of a display terminal used to display the video image at the play-back site.

6. The method of claim 1, wherein step (C) includes adjusting both the width and the height of the video image generated in step (B).

7. The method of claim 1, including the steps of:
(D) transmitting the selected video file over a network to a play-back site where the video image is to be generated,
(E) associating each of the video files with a corresponding network bandwidth, and,
(F) detecting the bandwidth of the network, and
wherein the video file selected in step (A) is based on the bandwidth detected in step (F).

8. The method of claim 7, wherein step (E) is performed by a system administrator.

9. The method of claim 7, wherein step (E) is performed at the play-back site.

10. The method of claim 7, including the step of selectively inhibiting the performance of step (C), and step (B) includes generating the video image in a fixed width and height.

11. The method of claim 1, including the step of collecting information relating to width and height of a display screen used to display the generated video image.

12. The method of claim 1, including the step of detecting the resolution setting of the display screen, and wherein step (C) includes adjusting the width and height of the video image to match the detected resolution stetting.

13. A video file play-back method, comprising the steps of:
(A) storing a plurality of video files representing the same video production but respectively having differing video play-back qualities;
(B) selecting one of the video files for play-back;
(C) optimizing the play-back by adjusting the width and/or the height of the video image to be displayed during the play-back based on the selection made in step (B); and,
(D) displaying the video image with a width and height optimized in step (C).

14. The method of claim 13, wherein the selection made in step (B) is based on the bandwidth of a network transmitting the selected video file to a screen used to display the video image.

15. The method of claim 13, including the steps of:
(E) associating the video files with a plurality of respectively associated network speeds; and
(F) detecting the speed of the network; and
wherein the video file selected in step (B) is based on the speed detected in step (F).

16. The method of claim 13, wherein step (C) includes adjusting the width and the height of the image to be displayed to match the resolution of a screen used to display the video image.

17. The method of claim 15, wherein step (C) includes adjusting the width and the height of the image to be displayed to match the resolution of the display screen.

18. The method of claim 13, wherein the selection made in step (B) is based on at least one of the following:
the type of video player available to a user for play-back of video files,
the bandwidth available in a network for transmission of video files to a user,
the format of each of the video files,
the type of platform available to the user for play-back of video files.

19. The method of claim 13, wherein the selection made in step (B) is based on a combination of:
the type of video player available to a user for play-back of video files,
the bandwidth available in a network for transmission of video files to a user,
the format of each of the video files,
the type of platform available to the user for play-back of video files.

20. A method for selecting and optimizing the play-back of video files transmitted by a network to a display screen, comprising the steps of:
(A) storing a plurality of video files representing the same video production but having differing video play-back qualities;
(B) detecting at least one of—
(i) the type of video player available to a user for play-back of video files,
(ii) the bandwidth available in the network,
(iii) the format of each of the video files,
(iv) the type of platform available to the user for play-back of video files.
(C) selecting one of the files provided in step (A) based on the information detected in step (B);
(D) playing back the video file selected in step (C); and,
(E) adjusting the height and/or width of the video image played back in step (D) based on the resolution of the display screen.

21. The method of claim 20, including the step of collecting information relating to the resolution of the display screen.

22. The method of claim 20, including the step of associating the video files with a plurality of respectively associated network speeds, wherein the step of detecting the bandwidth includes detecting the speed of the network, and the selection of the video file in step (C) is performed by selecting the file associated with the detected speed.
